(19) United States
(12) Patent Application Publication
(10) Pub. No.: US 2005/0139745 A1
(43) Pub. Date: Jun. 30, 2005

(54) Detachable base of a display

(75) Inventors: Chi-Cheng Liao, Taipei City (TW); Tsyr-Huey Liu, Taipei City (TW)

Correspondence Address: BACON & THOMAS, PLLC, 625 SLATERS LANE, FOURTH FLOOR, ALEXANDRIA, VA, 22314, US

(73) Assignee: Tatung Co., Ltd., Taipei City (TW)

(21) Appl. No.: 10/898,231

(22) Filed: Jul. 26, 2004

(30) Foreign Application Priority Data
Dec. 31, 2003 (TW) 092223094

(51) Int. Cl. B02B 5/02

(52) U.S. Cl. 248/346.01; 248/225.21

(57) ABSTRACT

A detachable base of a display includes: a connecting body mounted on a display body, a bottom face of the connecting body having at least one first sliding mechanism and a first retaining mechanism; and an undercarriage correspondingly mounted on the bottom face of the connecting body, the undercarriage having at least one second sliding mechanism and an operating section, wherein the at least one second sliding mechanism has an inlet end and a stop end, the operating section has an elastic region and an operating region, and the operating region located at a free end of the elastic region and another end of the elastic region fixed on the undercarriage.

### BACKGROUND OF THE INVENTION

1. Field of the Invention

The present invention relates to a detachable base of a display and, more particularly, to a detachable base of a flat panel display.

2. Description of the Related Art

Generally, the design for a base of a flat panel display requires stability for balance; therefore the size of the base is relatively large, which occupies a significant amount of packing space and causes difficulties with transportation.

Therefore, it is desirable to provide a detachable base of a display to mitigate and/or obviate the aforementioned problems.

### SUMMARY OF THE INVENTION

A main objective of the present invention is to provide a detachable base of a display, which is easy to assemble and disassemble, so that the display can be detached from the base to reduce the packing space for easier transportation.

In order to achieve the above mentioned objective, the detachable base comprises a connecting body mounted on a display body, a bottom face of the connecting body having at least one first sliding mechanism and a first retaining mechanism; and an undercarriage correspondingly mounted on the bottom face of the connecting body, the undercarriage having at least one second sliding mechanism and an operating section, wherein the at least one second sliding mechanism comprises an inlet end and a stop end, the operating section comprises an elastic region and an operating region, and the operating region is located at a free end of the elastic region and another end of the elastic region is fixed on the undercarriage; wherein the at least one first sliding mechanism of the connecting body is capable of sliding into the inlet end of the at least one second sliding mechanism until reaching the stop end, and the first retaining mechanism correspondingly retains the operating region of the operating section.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of a detachable base of a display of an embodiment according to the present invention.

FIG. 2A is a cross-sectional drawing along line AA′ for assembling the detachable base shown in FIG. 1 according to the present invention.

FIG. 2B is a cross-sectional drawing along line AA′ for disassembling the detachable base shown in FIG. 1 according to the present invention.

FIG. 3 is a cross-sectional drawing along line BB′ of the detachable base shown in FIG. 1 according to the present invention.

### DETAILED DESCRIPTION OF THE PREFERRED EMBODIMENT

A detachable base of a display of the present invention is suitable for a flat panel display, such as an LCD (liquid crystal display), FTD (field transmit display) or a plasma display. In the present invention, a second sliding mechanism can be a slot, and a first sliding mechanism can be a sliding segment that is capable of sliding into the slot. A first retaining mechanism can be a stopping segment that correspondingly pushes an operating region of an operating section of an undercarriage. There are preferably four first sliding mechanisms and four second sliding mechanisms. A free end of the elastic region of the operating section of the undercarriage connects to the undercarriage, and both are integrated together. The location of the first sliding mechanism and the first retaining mechanism are unlimited; preferably, the first sliding mechanisms are symmetrically located on the bottom face of the connecting body, and the first retaining mechanism is located in the center of the bottom face. The operating region of the operating section is a sheet-like element, which can be pushed by a human finger. The detachable base of the present invention is easy to assemble and disassemble, so that the display can be detached from the base to reduce the space requirements for packing, making for easier shipping.

An embodiment is provided in the following for further explanation.

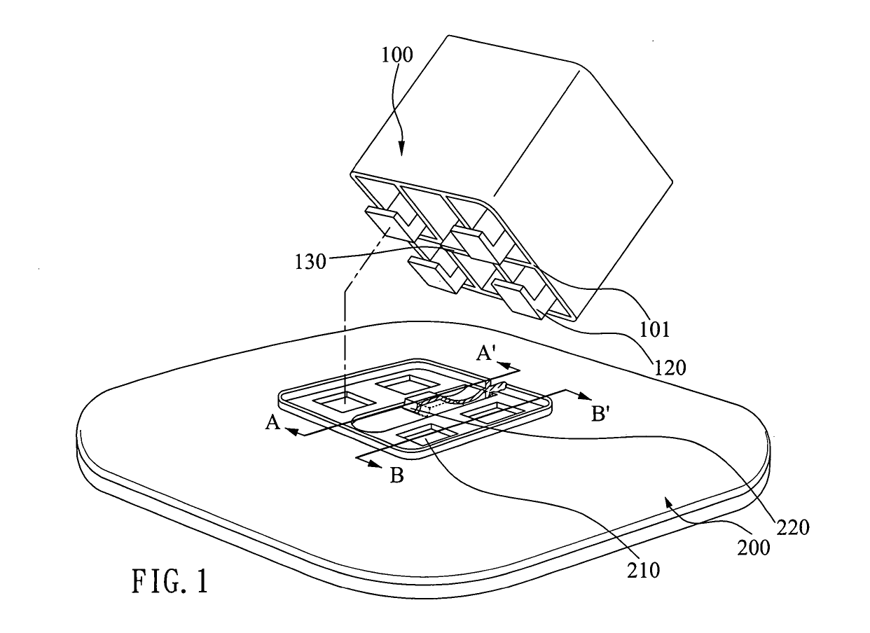

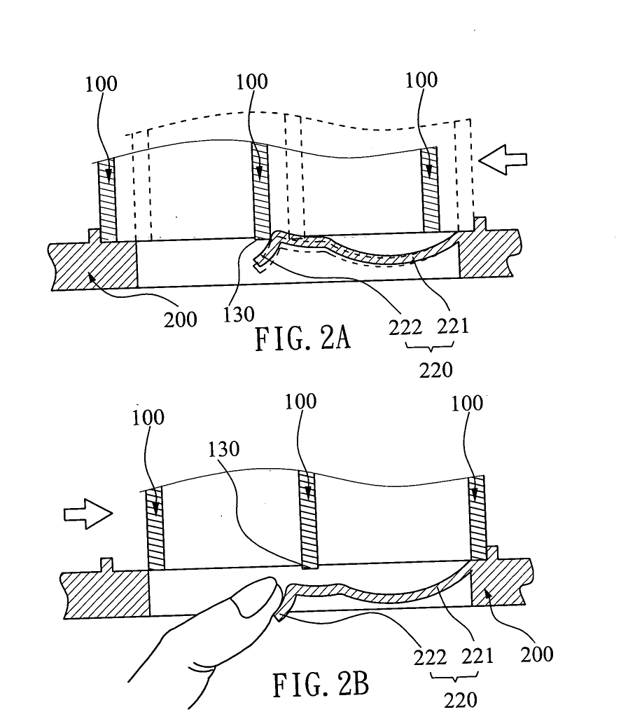

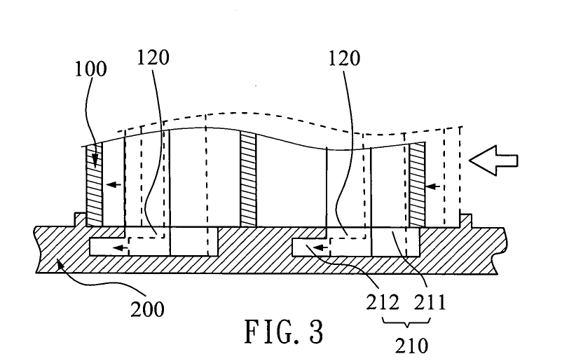

Please refer to FIG. 1, FIG. 2A, FIG. 2B, and FIG. 3. In this embodiment, the base is attached to a display; the base comprises a connecting body 100 and an undercarriage 200. The connecting body 100 is mounted on the display, and a bottom face 101 of the connecting body 100 has four first sliding mechanisms 120 (which are four L-shaped segments) and a first retaining mechanism 130 (which is a stopping segment). The undercarriage 200 is correspondingly mounted on the bottom face 101 of the connecting body 100, having four second sliding mechanisms 210 (which are four slots) and an operating section 220. The second sliding mechanisms 210, positioned corresponding to the first sliding mechanisms 120 of the connecting body 100, have inlet ends 211 and stop ends 212. The first sliding mechanisms 120 of the connecting body 100 are able to slide relative to the second sliding mechanisms 210. The operating section 220 comprises an elastic region 221 and an operating region 222, and the operating region 222 is located at a free end of the elastic region 221. The other end of the elastic region 221 is fixed on the undercarriage 200.

During assembly, the connecting body 100 is moved to slide the first sliding mechanisms 120 of the connecting body 100 from the inlet end 211 of the second sliding mechanisms 210 to the stop end 212 of the second sliding mechanisms 210. Meanwhile, the first retaining mechanism 130 of the connecting body 100 is moved from the elastic region 221 of the operating section 220 and pushes against the operating region 222 of the operating section 220. Therefore, the first sliding mechanisms 120 of the connecting body 100 become fixed in the stop end 212 of the second sliding mechanisms 210, and the first retaining mechanism 130 of the connecting body 100 pushes against the operating region 222 of the operating section 220; consequently, the connecting body 100 is fixed on the undercarriage 200 to finish the assembly process.

During disassembly, the operating region 222 of the operating section 220 is flipped (for example, by a human finger), so that an elastic force provided by the elastic region 221 of the operating section 220 causes the operating region 222 to leave the first retaining mechanism 130 of the connecting body 100. The connecting body 100 thus slides in an opposite direction on the undercarriage 200. Meanwhile, the first retaining mechanism 130 of the connecting body 100 moves back to the elastic region 221 of the operating section 220 to separate the connecting body 100 from the undercarriage 200.

The detachable base of the present invention is easy to assemble and disassemble, so the display can be easily detached from the base to reduce packing space requirements for easier transportation.

Although the present invention has been explained in relation to its preferred embodiment, it is to be understood that many other possible modifications and variations can be made without departing from the spirit and scope of the invention as hereinafter claimed.

1. A detachable base of a display comprising:
a connecting body mounted on a display body, a bottom face of the connecting body having at least one first sliding mechanism and a first retaining mechanism; and
an undercarriage correspondingly mounted on the bottom face of the connecting body, the undercarriage having at least one second sliding mechanism and an operating section, wherein the at least one second sliding mechanism has an inlet end and a stop end, and the operating section has an elastic region with one end fixed on the undercarriage and an operating region located at a free end of the elastic region;
wherein the at least one first sliding mechanism of the connecting body is capable of sliding into the inlet end of the at least one second sliding mechanism until reaching the stop end, and the first retaining mechanism correspondingly retains the operating region of the operating section.

2. The detachable base of a display as claimed in claim 1, wherein the at least one second sliding mechanism is a slot, and the at least one first sliding mechanism is an L-shaped sliding segment capable of sliding into the slot.

3. The detachable base of a display as claimed in claim 1, wherein the first retaining mechanism is a stopping segment and correspondingly pushes the operating region of the operating section of the undercarriage.

4. The detachable base of a display as claimed in claim 1 comprising four first sliding mechanisms and four second sliding mechanisms.

5. The detachable base of a display as claimed in claim 1, wherein the elastic region of the operating section of the undercarriage is connected to the undercarriage, and both the elastic region and the undercarriage are integrated together.
